(19) United States
(12) Patent Application Publication
(10) Pub. No.: US 2013/0157038 A1
(43) Pub. Date: Jun. 20, 2013

(54) COMPOSITE AND METHOD FOR MAKING THE SAME

(71) Applicants: HUANN-WU CHIANG, Tu-Cheng (TW); CHENG-SHI CHEN, Tu-Cheng (TW); YUAN-YUAN FENG, Shenzhen City (CN); YU-QIANG WANG, Shenzhen City (CN); TING-TING GE, Shenzhen City (CN); DAI-YU SUN, Shenzhen City (CN); GUANG-HUI LI, Shenzhen City (CN)

(72) Inventors: HUANN-WU CHIANG, Tu-Cheng (TW); CHENG-SHI CHEN, Tu-Cheng (TW); YUAN-YUAN FENG, Shenzhen City (CN); YU-QIANG WANG, Shenzhen City (CN); TING-TING GE, Shenzhen City (CN); DAI-YU SUN, Shenzhen City (CN); GUANG-HUI LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/403,528

(22) Filed: Feb. 23, 2012

(30) Foreign Application Priority Data
Dec. 15, 2011 (CN) 201110420534.6

(51) Int. Cl. B32B 3/26; B05D 3/06

(52) U.S. Cl. 428/304.4; 427/555; 427/556

(57) ABSTRACT

A composite includes a substrate and at least a resin composition formed on the substrate. A surface of the substrate is defined a plurality of micro-pores therein. The resin composition is coupled to the surface having the micro-pores by the resin composition filling and hardening within the micro-pores. The resin composition contains crystalline thermoplastic synthetic resins. A method for making the composite is also described.

### BACKGROUND

1. Technical Field

The present disclosure relates to composites, particularly to a composite having high bonding strength and a method for making the composite.

2. Description of Related Art

Adhesives, for combining heterogeneous materials in the form of a metal and a synthetic resin are in demand in a wide variety of technical fields and industries, such as the automotive and household appliance fields. However, the bonding strength of the metal and resin is weak. Furthermore, adhesives are generally only effective in a narrow temperature range of about −50° C. to about 100° C., which means they are not suitable in applications where operating or environmental temperatures may fall outside of the range. Due to the above reason, other bonding methods have been applied that do not involve the use of an adhesive. One example of such methods is by forming bonds through injection molding or other similar process. However, the bonding strength of the metal and resin can be further improved.

Therefore, there is room for improvement within the art.

### BRIEF DESCRIPTION OF THE FIGURES

Many aspects of the disclosure can be better understood with reference to the following figures. The components in the figures are not necessarily drawn to scale, the emphasis instead being placed upon clearly illustrating the principles of the disclosure. Moreover, in the drawings like reference numerals designate corresponding parts throughout the several views.

FIG. 1 is a cross-sectional view of an exemplary embodiment of a composite.

FIG. 2 is a scanning electron microscopy view of an exemplary embodiment of a substrate being laser etched.

FIG. 3 is a scanning electron microscopy view of a cross-section at the combine of the substrate and the resin composition.

FIG. 4 is a scanning electron microscopy view of a surface of the substrate combining to the resin composition.

FIG. 5 is a cross-sectional view of a mold of the composite shown in FIG. 1.

### DETAILED DESCRIPTION

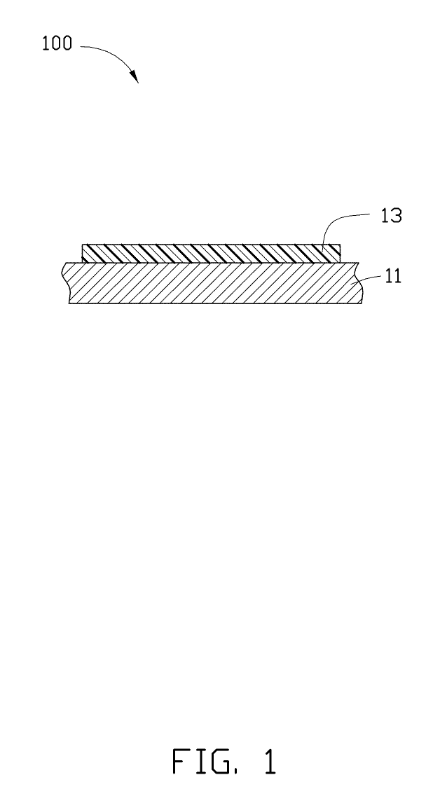

FIG. 1 shows a composite 100 according to an exemplary embodiment. The composite 100 includes a substrate 11, and at least a resin composition 13 formed on the substrate 11.

The substrate 11 may be made of metal, glass, or ceramic. The metal can be stainless steel, magnesium alloy, or copper alloy.

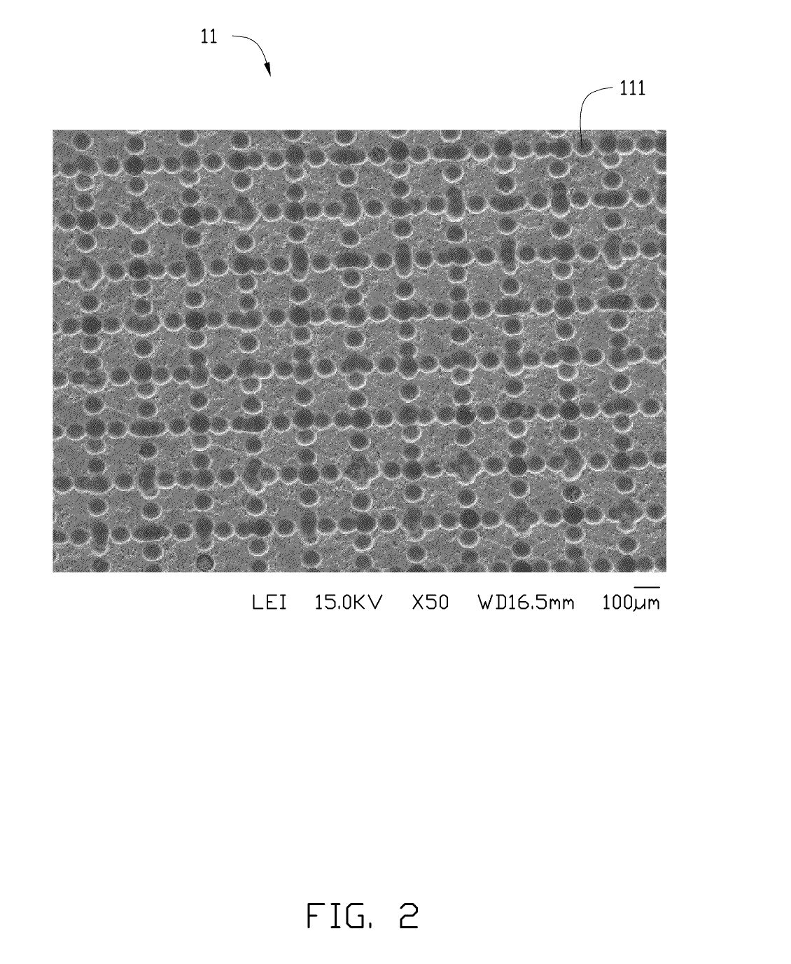

Referring to FIG. 2, a plurality of micro-pores 111 are defined in a surface of the substrate 11. The pore diameter of the micro-pores 111 may be in a range of about 1 micrometer (μm) to about 100 μm, and the pore depth of the micro-pores 111 may be in a range of about 1 μm-about 200 μm. Each two adjacent micro-pores 111 have a space between them of about 10 μm-about 200 μm.

It should be understood that, the pore diameter and the pore depth of the micro-pores 111, and the space of each two micro-pores 111 can be adjusted.

In the embodiment, the micro-pores 111 are regularly distributed in an array in the surface of the substrate 11. Alternately, the micro-pores 111 can be irregularly distributed in the surface of the substrate 11.

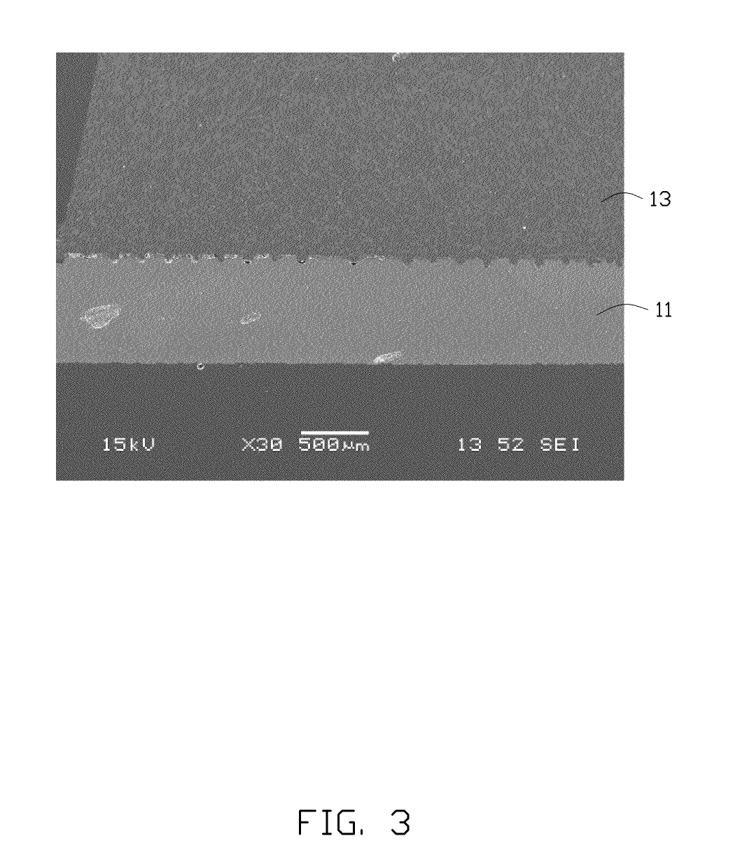

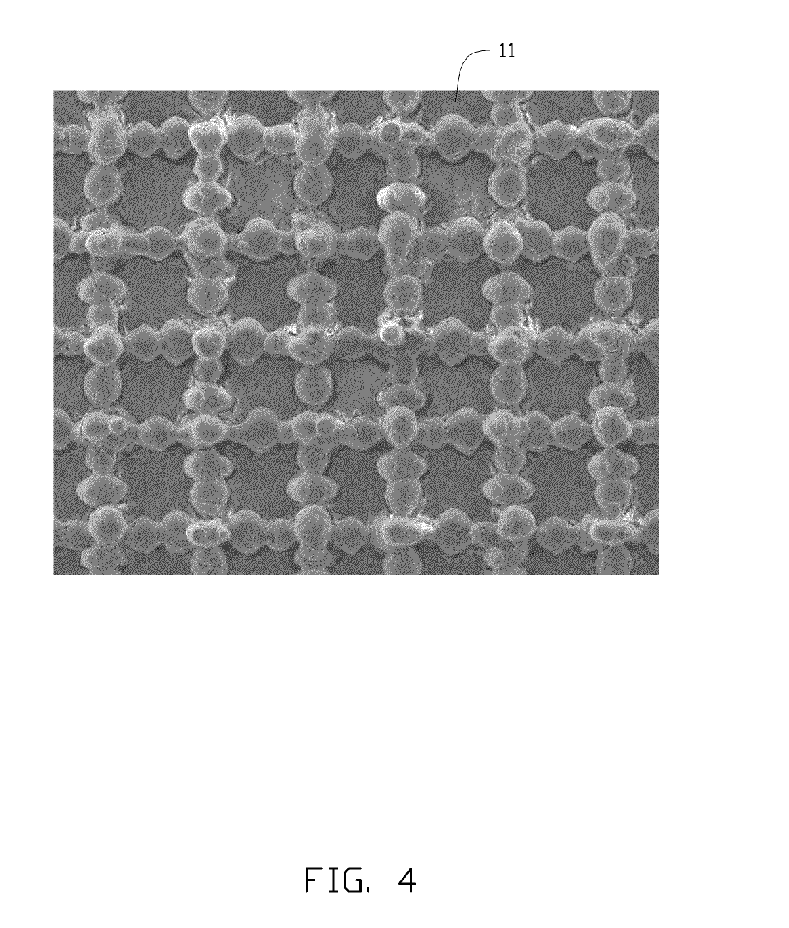

Referring to FIGS. 3 and 4, the resin composition 13 is coupled to the surface of the substrate 11 having the micro-pores 111 and fills the micro-pores 111. That is, a portion of the resin composition 13 insert in the micro-pores 111, which causes a locking/catching effect and strongly bonding the resin composition 13 to the substrate 11.

The resin composition 13 may be coupled to the substrate 11 by molding. The resin composition 13 may be made up of crystalline thermoplastic synthetic resins having high fluidity. In the exemplary embodiment, polyphenylene sulfide (PPS), polyamide (PA), polybutylene terephthalate (PBT), or polyethylene terephthalate (PET) can be selected as the molding materials for the resin composition 13. The resin composition 13 can bond firmly with the substrate 11. The molding materials can be added with some fiberglass to improve the property for molding.

A method for making the composite 100 may include the following steps:

The substrate 11 is provided.

The substrate 11 is cleaned. The cleaning process may be carried out by dipping the substrate 11 in a water solution containing Nat The water solution may contain sodium carbonate, sodium phosphate, and sodium silicate. The sodium carbonate may have a mass concentration of about 30 g/L-about 50 g/L. The sodium phosphate may have a mass concentration of about 30 g/L-about 50 g/L. The sodium silicate may have a mass concentration of about 3 g/L-about 5 g/L. During the dipping process, the water solution may keep at about 50° C.-about 60° C. The dipping process may last about 5 min-about 15 min After that, the substrate 11 is rinsed.

The substrate 11 is laser etched to form the micro-pores 111 in a surface of the substrate 11. The laser etching process may be carried out using a laser machine having the parameters of, power: about 10 W-about 30 W, frequency: about 20 KHZ-about 60 KHZ, and step length: about 0.005 μm-about 0.1 μm.

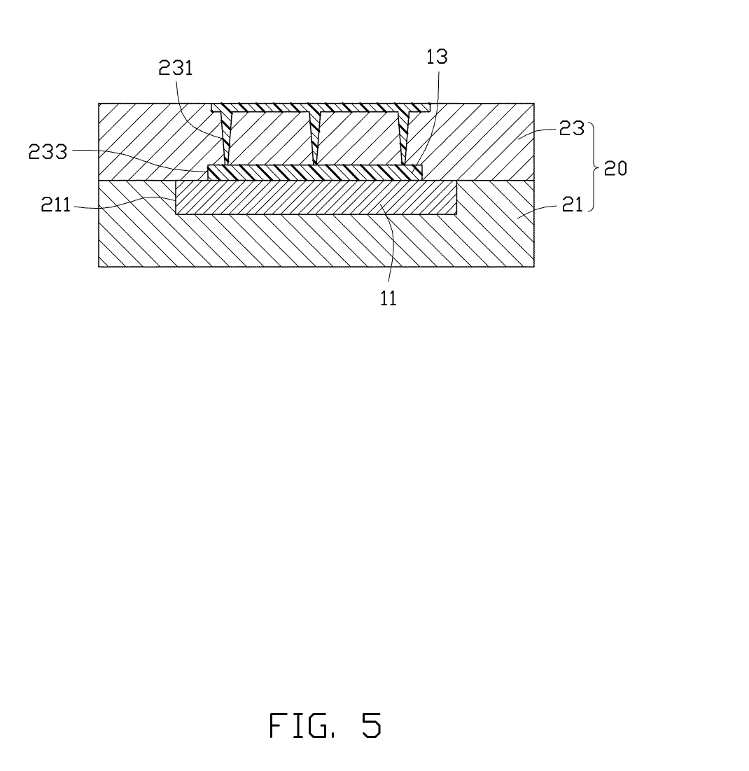

Referring to FIG. 5, an injection mold 20 is provided. The injection mold 20 includes a core insert 23 and a cavity insert 21. The core insert 23 defines several gates 231, and a first cavity 233. The cavity insert 21 defines a second cavity 211 for receiving the substrate 11. The substrate 11 having the micro-pores 111 is located in the second cavity 211, and molten resin is injected through the gates 231 to coat the surface of the substrate 11 and fill the micro-pores 111, and finally fill the first cavity 233 to form the resin composition 13, as such, the composite 100 is formed. The molten resin may be crystalline thermoplastic synthetic resins having high fluidity, such as PPS, PA, PBT, or PET. During the molding process, the injection mold 20 keeps a temperature of about 120° C.-about 140° C.

Tensile strength and shear strength of the composite 100 have been tested. The tests indicated that the shear strength of the composite 100 was about 20 MPa-about 30 MPa, and the tensile strength of the composite 100 was about 8 MPa-about 16 MPa. Furthermore, the composite 100 has been subjected to a temperature humidity bias test (72 hours, 85° C., relative humidity: 85%) and a thermal shock test (48 hours, −40° C.-85° C., 4 hours/cycle, 12 cycles total), such testing did not result in decreased the shear strength and the tensile strength of the composite 100.

The exemplary method of forming the micro-pores 111 is very effectively comparing to the conventional chemical etching, electrochemical etching or anodizing treating, and simultaneously fit for multiple materials.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A composite, comprising:
a substrate, a surface of the substrate having a plurality of micro-pores defined therein; and
at least a resin composition coupled to the surface having the micro-pores by the resin composition filling and hardening within the micro-pores, the resin composition containing crystalline thermoplastic synthetic resins.

2. The composite as claimed in claim 1, wherein diameter of the micro-pores is in a range of about 1 μm-100 μm, depth of the micro-pores is in a range of about 1 μm-200 μm, and each two adjacent micro-pores have a space between them of about 10 μm-200 μm.

3. The composite as claimed in claim 1, wherein the micro-pores are regularly distributed in an array in the surface of the substrate.

4. The composite as claimed in claim 1, wherein the micro-pores are irregularly distributed in the surface of the substrate.

5. The composite as claimed in claim 1, wherein the substrate is made of metal, glass, or ceramic.

6. The composite as claimed in claim 5, wherein the metal is stainless steel, aluminum alloy, magnesium alloy, or copper alloy.

7. The composite as claimed in claim 1, wherein the resin composition is a molded crystalline thermoplastic synthetic resin composition.

8. The composite as claimed in claim 1, wherein the crystalline thermoplastic synthetic resin is polyphenylene sulfide, polyamide, polybutylene terephthalate, or polyethylene terephthalate.

9. The composite as claimed in claim 8, wherein the crystalline thermoplastic synthetic resin is added with fiberglass.

10. The composite as claimed in claim 1, wherein a portion of the resin composition insert in and fill the micro-pores of the substrate.

11. A method for making a composite, comprising:
providing a substrate;
laser etching the substrate to form a plurality of micro-pores in a surface of the substrate; and
inserting the substrate in a mold and molding crystalline thermoplastic synthetic resin on the surface of the substrate having the micro-pores to form the composite by the resin composition filling and hardening within the micro-pores.

12. The method as claimed in claim 11, wherein diameter of the micro-pores is in a range of about 1 μm-100 μm, depth of the micro-pores is in a range of about 1 μm-200 μm, and each two adjacent micro-pores have a space between them of about 10 μm-200 μm.

13. The method as claimed in claim 11, wherein the laser etching process is carried out using a laser machine having the parameters of, power: 10 W-30 W, frequency: 20 KHZ-60 KHZ, and step length: 0.005 μm-0.1 μm.

14. The method as claimed in claim 11, wherein the substrate is made of metal, glass, or ceramic.

15. The method as claimed in claim 14, wherein the metal is stainless steel, aluminum alloy, magnesium alloy, or copper alloy.

16. The method as claimed in claim 11, wherein the crystalline thermoplastic synthetic resin is polyphenylene sulfide, polyamide, polybutylene terephthalate, or polyethylene terephthalate.

17. The method as claimed in claim 11, wherein a portion of the crystalline thermoplastic synthetic resin insert in and fill the micro-pores of the substrate.

18. The method as claimed in claim 11, wherein the micro-pores are regularly distributed in an array in the surface of the substrate.

19. The method as claimed in claim 11, wherein the micro-pores are irregularly distributed in the surface of the substrate.

20. A composite, comprising:
a substrate, a surface of the substrate being laser etched to form a plurality of micro-pores therein; and
at least a molded resin composition coupled to the surface having the micro-pores by the resin composition filling and hardening within the micro-pores, the resin composition containing crystalline thermoplastic synthetic resins.
